(19) United States
(12) Patent Application Publication
(10) Pub. No.: US 2025/0304858 A1
(43) Pub. Date: Oct. 2, 2025

(54) PYROLYSIS APPARATUS FOR SOLID HYDROCARBON FEEDSTOCK, AND PROCESS METHOD THEREOF

(71) Applicant: SHENYANG UNIVERSITY OF CHEMICAL TECHNOLOGY, Liaoning (CN)

(72) Inventors: Guangwen XU, Liaoning (CN); Dengguo LAI, Liaoning (CN); Zhennan HAN, Liaoning (CN); Xin JIA, Liaoning (CN); Jiguang CHENG, Liaoning (CN); Xingfei SONG, Liaoning (CN)

(73) Assignee: SHENYANG UNIVERSITY OF CHEMICAL TECHNOLOGY, Liaoning (CN)

(21) Appl. No.: 19/237,050

(22) Filed: Jun. 13, 2025

Related U.S. Application Data
(63) Continuation of application No. PCT/CN2023/074202, filed on Feb. 2, 2023.

(30) Foreign Application Priority Data
Dec. 14, 2022 (CN) 202211600410.0

(51) Int. Cl. C10B 27/02; C10B 3/00; C10B 21/04; C10B 31/02; C10L 3/10

(52) U.S. Cl. CPC C10B 27/02; C10B 3/00; C10B 21/04; C10B 31/02; C10L 3/10

(57) ABSTRACT

A pyrolysis apparatus for solid hydrocarbon feedstock and a process method thereof are related to a pyrolysis apparatus and a process method thereof. A multi-tubular pyrolysis reactor of the apparatus is composed of one or more tubular pyrolysis reactors that are arranged in a tube-by-tube manner, its heating section being arranged in a heating chamber. A pyrolysis gas obtained from feedstock pyrolysis or an externally supplied fuel gas is combusted in the heating chamber through a regenerative combustion, so as to provide heat for the pyrolytic reaction. A gas collecting internal component is arranged at a center of each tubular pyrolysis reactor, and a pyrolysis gas product is regulated to radially flow across a moving particle bed so as to achieve in-situ filtering dust removal and selective cracking upgrading.

### CROSS-REFERENCE TO RELATED APPLICATIONS

The present application is a continuation of International Application No. PCT/CN2023/074202, filed Feb. 2, 2023, which claims priority to Chinese Patent Application No. 202211600410.0, filed Dec. 14, 2022, both of which are hereby incorporated by reference in their entireties.

### TECHNICAL FIELD

The present application relates to a pyrolysis apparatus and a process method thereof, in particular to a pyrolysis apparatus for solid hydrocarbon feedstock and a process method thereof.

### BACKGROUND

Solid hydrocarbon feedstocks include coal, oil shale, waste tires, biomass, oil sands, urban organic solid waste, etc., which can be converted into oil, gas, char and other product through pyrolysis. Pyrolysis oil can serve as a fuel to replace fossil fuel oil, or as a chemical feedstock to produce high-value-added chemical product; pyrolysis gas can be used as a fuel gas for energy supply or as a feedstock gas; pyrolytic char can be applied according to respective characteristics and properties, for example, biochar can be used for soil improvement and remediation; waste tire pyrolysis char can be used for preparation of carbon black; coal semi-coke can be used for combustion power generation and metallurgy, and specifically, for preparation of carbon materials of negative electrode of a battery, and the like.

Currently reported representative pyrolysis technologies for solid hydrocarbon feedstock include Fushun Retort Furnace from China, Toscoal Rotary Retort Furnace from the United States, Galoter Rotary Retort Furnace from Estonia, ATP Rotary Kiln Process from Canada, Lurgi-Ruhr Moving Bed Pyrolysis from Germany, Novel Retorting Process from Dalian University of Technology in China, etc. Among them, the pyrolysis technology for large-scale industrial applications is currently limited to utilization of lump-sized feedstock, resulting in bulk accumulation and discarding of up to 40% or more of small-particle feedstock. In addition, an oil yield obtained by the existing lump-sized feedstock pyrolysis technology is relatively low. The development of corresponding pyrolysis technologies for small-particle solid hydrocarbon feedstock has undergone decades, and most pyrolysis technologies have been demonstrated with hundreds to thousands of tons daily. However, there is no technology that can achieve long-term stable operation of industrialization. The main problems faced by these technologies are low yield of pyrolysis oil, high content of heavy components in the oil, poor quality, and serious dust carrying, which leads to pipeline blockage and difficulty in continuous operation, and poor economic benefits. In addition, the traditional approach to industrial scale-up applications through reactor size amplification can not only increase operational difficulty but also tend to trigger problems in the amplified reactor, including non-uniform heat transfer, decreased heat/mass transfer efficiency, significant reduction in operation effect compared to small reactors, etc.

The pyrolysis process can be roughly divided into two stages: an organic substance in the solid hydrocarbon feedstock is thermally decomposed to produce a primary pyrolysis product; the primary pyrolysis product is released from a particle to a particle bed layer and a reactor, and secondary reactions of pyrolysis oil and gas occur during the process of being exported from the reactor, including reactions between pyrolysis gas-phase products and between pyrolysis gas-phase products and solid particles, and finally pyrolysis oil and pyrolysis gas are separated and collected. In principle, in order to obtain high-yield and high-quality pyrolysis oil, it is necessary to maximize a yield of the primary pyrolysis product and meantime regulate the secondary reaction of the primary pyrolysis product, realizing the improvement of the quality of pyrolysis oil. In terms of dust carrying, small-particles or powder particles feedstocks move violently in the reactor such as a fluidized bed and a rotary kiln during the pyrolysis process, and the dust raised in the reactor is carried out of the reactor with the pyrolysis gas-phase product, which eventually results in a high dust content in the pyrolysis oil. Usually, a dust removal operation needs to be added at the stage of collection and separation of pyrolysis gas-phase product, such as a cyclone dust removal and a particle bed dust removal, but these equipment not only make the process complicated, difficult to operate and poor in dust removal, but also make the pyrolysis oil and gas undergo secondary reactions, resulting in a significant reduction in oil yield. Therefore, in order to solve the common problems faced by small-particle feedstock pyrolysis technology, such as low yield of product oil, high content of heavy components, high dust content, and difficulty in scale-up technology.

### SUMMARY

The objective of the present application is to provide a pyrolysis apparatus for solid hydrocarbon feedstock and a process method thereof. The present application utilizes a self-generated pyrolysis gas from the system, employing a direct combustion and heating via a regenerative combustion. A single heating unit can accommodate multiple tubular pyrolysis reactors to achieve rapid and efficient heat and mass transfer, which is more energy-saving and efficient and simplifies the heating unit, solving the problems of a low oil yield, heavy oils, high dust content, etc. in the pyrolysis of small-particle solid hydrocarbon feedstock and overcoming the difficulty of industrial scale-up application of pyrolysis reactors and pyrolysis technology.

The objective of the present application is achieved through technical solutions as follows.

The present application discloses a pyrolysis apparatus for solid hydrocarbon feedstock, including: a feeder, a multi-tubular pyrolysis reactor, regenerative burners, a heating chamber, a solid product discharger, a gas collecting internal component, a gas product collecting pipe, and a gas product condenser.

The multi-tubular pyrolysis reactor is formed by one tubular pyrolysis reactor or more tubular pyrolysis reactors in combination. The tubular pyrolysis reactor is generally cylindrical in shape, and the gas collecting internal component is arranged at a center of each reactor.

The present application is based on a method of quantity amplification, and adopts a combination of tubular pyrolysis reactors to construct a multi-tubular pyrolysis reactor, so that the industrial reactor is easier to be scaled up; the size of the tubular pyrolysis reactor is not significantly changed compared with the verified small-scale pyrolysis reactor, and the tubular pyrolysis reactor has simple operation and manipulation and good effect of heat and mass transfer, which solves the problems of difficulty in industrial scale-up of reactors, poor operation effect of scaled-up reactors, and great operation difficulty.

The gas collecting internal component is usually cylindrical in shape, and is provided with a channel or a pore for allowing a gas product to pass through. A lower end of the internal component is opened into a material layer of the pyrolysis reactor, and an upper end is in a gas-tight communication with the gas product collecting pipe, so as to guide a pyrolysis gas product out of the pyrolysis reactor and into the gas product condenser.

In the present application, a gas collecting internal component is provided at a center of the pyrolysis reactor, which has the following advantages: regulating a radial flow of a pyrolysis gas product across a moving particle bed, with a flowing from a high temperature zone of an external wall of the reactor to its central low temperature zone, which realizes a selective cracking of the heavy components and inhibits excessive secondary reaction; facilitating to strengthen the heat transfer of the material in the reactor, which significantly improves a heat transfer efficiency and the processing capacity per unit time of the pyrolysis apparatus; avoiding a reverse flow of the pyrolysis gas product (from bottom to top) and the material (from top to bottom), greatly reducing the dust carrying of the gas product, and realizing in-situ filtering and dust removal by the particle moving bed. Compared with the reactor without a gas collecting internal component, the pyrolysis reactor and the pyrolysis apparatus of the present application obtain a significantly improved product oil yield and quality, a faster heat transfer rate, and a significantly reduced dust content in product oil.

A heating section of the multi-tubular pyrolysis reactor is placed in the heating chamber, and the tubular pyrolysis reactor is arranged in the heating chamber in a tube-by-tube manner.

The heating chamber is an indoor combustion chamber, which provides a heat for a pyrolysis reaction through combustion of a combustible gas. One or more tubular pyrolysis reactors can be arranged in the heating chamber.

The regenerative burners are symmetrically distributed above and below the heating chamber, or at sides of the heating chamber.

In an embodiment, the regenerative burner uses the combustible gas as fuel, where the combustible gas is selected from any one of a pyrolysis gas, a natural gas, a gasified coal gas, and a petroleum gas, or a combination thereof. In an embodiment, the pyrolysis gas separated by the gas product condenser is used as a gas fuel.

The regenerative combustion used in the present application can effectively utilize a heat of a flue gas after combustion and improve the energy utilization efficiency of the system; and the indoor combustion gas fuel is used to directly provide energy for the pyrolysis reaction, avoiding the problem of difficult conversion for high-temperature flue gas and large heat loss in outdoor combustion.

The gas product collecting pipe is connected to outlets of gas collecting internal components of tubular pyrolysis reactors in the same row, and introduces the pyrolysis gas product into the gas product condenser.

The present application also provides a method for pyrolysis of solid hydrocarbon feedstock, including steps as follows.

A solid hydrocarbon feedstock is fed into a tubular pyrolysis reactor through a feeder, respectively, where the feedstock is heated and subjected to a pyrolysis reaction during a downward movement in a tubular pyrolysis reactor, releasing a pyrolysis gas product; the gas product flows radially across a moving particle bed, enters a gas collecting internal component through a pore or a channel, and then is collected to a gas product condenser through the gas product collecting pipe for cooling and separation; the separated pyrolysis gas and/or an external fuel gas are mixed with air and introduced by regenerative burners and burned in a heating chamber to supply heat for the pyrolysis reactor; a solid product obtained after the pyrolysis reaction is discharged from the pyrolysis reactor through a solid product discharger after cooling and heat exchange, and enters a downstream processing section. The whole process runs continuously.

The present application gives rise to the following beneficial effects.
1. Based on the method of “quantity amplification” of tubular pyrolysis reactors for industrial reactor scale-up application, the present application forms a multi-tubular pyrolysis reactor by arranging and combining the tubular reactors in a tube-by-tube manner, avoiding the problems caused by traditional reactor scale-up method based on the size scale-up of the reactor, such as the decrease of heat/mass transfer efficiency, the increase of operation difficulty, and the decrease of amplification operation effect, and making the industrial scale amplification easier and the operation simpler.
2. The tubular pyrolysis reactor used in the present application is provided with a gas collecting internal component to regulate a radial flow of a pyrolysis gas product through a moving particle bed, enabling a flow from an external high temperature zone to an internal low temperature zone, which is beneficial to reduce the secondary reaction of the gas product and achieve a selective cracking of the heavy components, ultimately improving the yield and quality of the pyrolysis oil. In addition, the flow of the gas product from the high temperature zone to the low temperature zone, also significantly improves the heat transfer rate.
3. The tubular pyrolysis reactor with the gas collecting internal component used in the present application realizes radial flow of pyrolysis gas product, and can intercept dust in pyrolysis gas product by the moving particle bed, realize in-situ filtration and dust removal, and solve the problems of high dust content in the pyrolysis product oil of small-particle solid hydrocarbon feedstocks and easy clogging of pipelines.
4. The present application can utilize a self-generated pyrolysis gas from the system, employing a direct combustion and heating via a regenerative combustion. Moreover, a single heating unit can accommodate multiple tubular pyrolysis reactors. Compared with the traditional coke oven, it can achieve rapid and efficient heat and mass transfer, making it more energy-saving and efficient; and the heating unit is simpler.

### BRIEF DESCRIPTION OF DRAWINGS

FIG. 1 is a diagram of a pyrolysis apparatus for solid hydrocarbon feedstock according to Embodiment 1.

FIG. 2 is a diagram of a pyrolysis apparatus for solid hydrocarbon feedstock according to Embodiment 2.

FIG. 3 is a top view of the pyrolysis apparatus and a layout diagram of regenerative burners according to Embodiment 2.

FIG. 4 is a top view of a pyrolysis apparatus and a layout diagram of regenerative burners according to Embodiment 3.

### DESCRIPTION OF EMBODIMENTS

The technical solution of the present application is further described below by specific embodiments. It should be understood by those skilled in the art that the embodiments are only intended to facilitate understanding the present application and should not be regarded as specific limitations of the present application.

### Embodiment 1

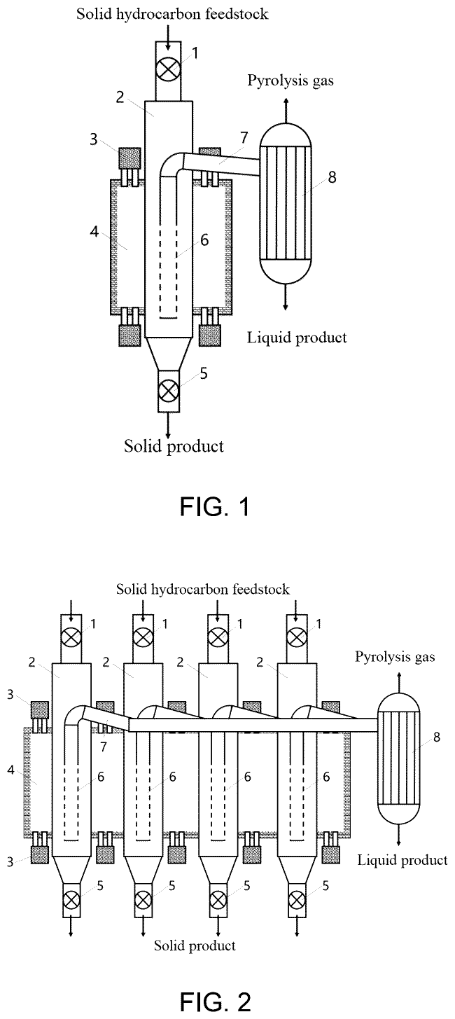

As shown in FIG. 1, a pyrolysis apparatus for solid hydrocarbon feedstock is provided, including: a feeder 1, a multi-tubular pyrolysis reactor 2, regenerative burners 3, a heating chamber 4, a solid product discharger 5, a gas collecting internal component 6, a gas product collecting pipe 7, and a gas product condenser 8. The multi-tubular pyrolysis reactor 2 is formed by one tubular pyrolysis reactor. The tubular pyrolysis reactor is cylindrical in shape, and the gas collecting internal component 6 is arranged at a center of the reactor.

The gas collecting internal component 6 is cylindrical in shape and is provided with a channel for allowing a gas product to pass through. A lower end of the internal component is opened into a material layer of the pyrolysis reactor, and an upper end of the internal component is in a gas-tight communication with the gas product collecting pipe 7, so as to guide a pyrolysis gas product out of the pyrolysis reactor and into the gas product condenser 8.

A heating section of the multi-tubular pyrolysis reactor 2 is placed in the heating chamber 4.

The heating chamber 4 is an indoor combustion chamber, which provides a heat for the pyrolysis reaction through combustion of the pyrolysis gas. One tubular pyrolysis reactor is arranged in the heating chamber.

The regenerative burners 3 are symmetrically distributed above and below the heating chamber 4; and the regenerative burners 3 use the pyrolysis gas separated by the gas product condenser 8 as a fuel.

The gas product collecting pipe 7 is connected to an outlet of the gas collecting internal component 6 of the tubular pyrolysis reactor, and introduces the pyrolysis gas product into the gas product condenser 8.

### Embodiment 2

As shown in FIG. 2, a pyrolysis apparatus for solid hydrocarbon feedstock is provided, which includes: a feeder 1, a multi-tubular pyrolysis reactor 2, regenerative burners 3, a heating chamber 4, a solid product discharger 5, a gas collecting internal component 6, a gas product collecting pipe 7, and a gas product condenser 8.

The multi-tubular pyrolysis reactor 2 is formed by a combination of eight tubular pyrolysis reactors. The tubular pyrolysis reactor is cylindrical in shape, and the gas collecting internal component 6 is arranged at a center of each reactor.

The gas collecting internal component 6 is cylindrical in shape and is provided with a channel for allowing a gas product to pass through. A lower end of the internal component is opened into a material layer of the pyrolysis reactor, and an upper end of the internal component is in a gas-tight communication with the gas product collecting pipe 7, so as to guide a pyrolysis gas product out of the pyrolysis reactors and into the gas product condenser 8.

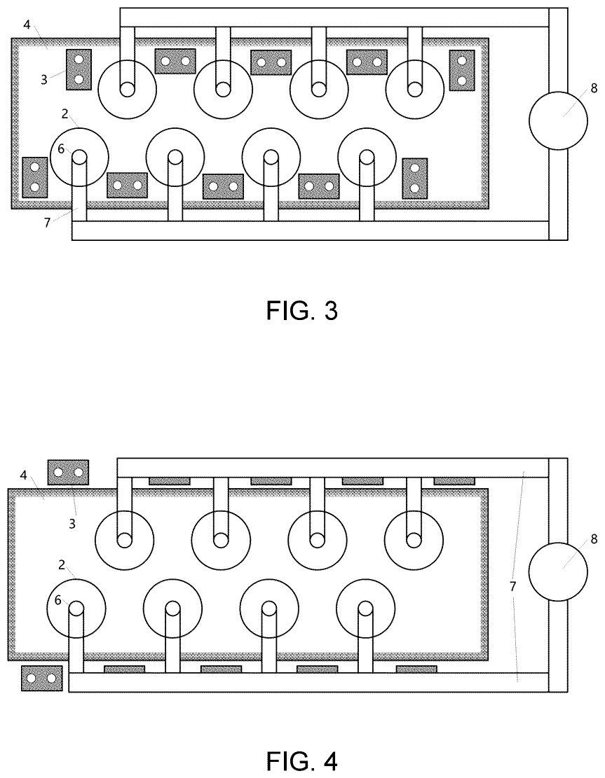

A heating section of the multi-tubular pyrolysis reactor 2 is placed in the heating chamber 4, and eight tubular pyrolysis reactors are arranged in the heating chamber 4 in a tube-by-tube manner. As shown in FIG. 3, every four tubular pyrolysis reactors form a row, and there are two rows of staggered reactors in the heating chamber.

The heating chamber 4 is an indoor combustion chamber, which provides a heat for the pyrolysis reaction through combustion of a natural gas. Eight tubular pyrolysis reactors can be arranged in the heating chamber.

As shown in FIG. 3, the regenerative burners 3 are symmetrically distributed above and below the heating chamber 4, and use the natural gas as a fuel.

The gas product collecting pipe 7 is connected to outlets of the gas collecting internal components 6 of four tubular pyrolysis reactors in the same row, and introduces the pyrolysis gas product into the gas product condenser 8.

### Embodiment 3

As shown in FIG. 2, a pyrolysis apparatus for solid hydrocarbon feedstock is provided, which includes: a feeder 1, a multi-tubular pyrolysis reactor 2, a regenerative burner 3, a heating chamber 4, a solid product discharger 5, a gas collecting internal component 6, a gas product collecting pipe 7, and a gas product condenser 8.

The multi-tubular pyrolysis reactor 2 is formed by a combination of eight tubular pyrolysis reactors. The tubular pyrolysis reactor is cylindrical in shape, and the gas collecting internal component 6 is arranged at a center of each reactor.

The gas collecting internal component 6 is cylindrical in shape and is provided with a pore for allowing a gas product to pass through. A lower end of the internal component is opened into a material layer of the pyrolysis reactor, and an upper end of the internal component is in a gas-tight communication with the gas product collecting pipe 7, so as to guide a pyrolysis gas product out of the pyrolysis reactors and into the gas product condenser 8.

A heating section of the multi-tubular pyrolysis reactor 2 is placed in the heating chamber 4, and eight tubular pyrolysis reactors are arranged in the heating chamber 4 in a tube-by-tube manner. As shown in FIG. 4, every four tubular pyrolysis reactors form a row, and there are two rows of staggered reactors in the heating chamber.

The heating chamber 4 is an indoor combustion chamber, which provides a heat for the pyrolysis reaction through combustion of a gasified coal gas. Eight tubular pyrolysis reactors can be arranged in the heating chamber.

As shown in FIG. 4, the regenerative burners 3 are symmetrically distributed at sides of the heating chamber 4, and use the gasified coal gas as a fuel.

The gas product collecting pipe 7 is connected to outlets of the gas collecting internal components 6 of four tubular pyrolysis reactors in the same row, and introduces the pyrolysis gas product into the gas product condenser 8.

### Embodiment 4

A pyrolysis apparatus for solid hydrocarbon feedstock is provided, which includes: a feeder 1, a multi-tubular pyrolysis reactor 2, a regenerative burner 3, a heating chamber 4, a solid product discharger 5, a gas collecting internal component 6, a gas product collecting pipe 7, and a gas product condenser 8.

The multi-tubular pyrolysis reactor 2 is formed by a combination of sixteen tubular pyrolysis reactors. The tubular pyrolysis reactor is cylindrical in shape, and the gas collecting internal component 6 is arranged at a center of each reactor.

The gas collecting internal component 6 is cylindrical in shape and is provided with a pore for allowing a gas product to pass through. A lower end of the internal component is opened into a material layer of the pyrolysis reactor, and an upper end of the internal component is in a gas-tight communication with the gas product collecting pipe 7, so as to guide a pyrolysis gas product out of the pyrolysis reactor and into the gas product condenser 8.

A heating section of the multi-tubular pyrolysis reactor 2 is placed in the heating chamber 4, and sixteen tubular pyrolysis reactors are arranged in the heating chamber 4 in a tube-by-tube manner.

The heating chamber 4 is an indoor combustion chamber, which provides a heat for the pyrolysis reaction through combustion of the pyrolysis gas. Sixteen tubular pyrolysis reactors can be arranged in the heating chamber.

The regenerative burners 3 are symmetrically distributed above and below the heating chamber 4; the regenerative burners 3 use the pyrolysis gas separated by the gas product condenser 8 as a fuel.

The gas product collecting pipe 7 is connected to outlets of the gas collecting internal components 6 of the tubular pyrolysis reactors in the same row, and introduces the pyrolysis gas product into the gas product condenser 8.

### Embodiment 5

A pyrolysis method based on a pyrolysis apparatus for solid hydrocarbon feedstock is provided, including the following steps:
a solid hydrocarbon feedstock is fed into eight tubular pyrolysis reactors through eight feeders 1, respectively, where the feedstock is heated and subjected to a pyrolysis reaction during a downward movement in a multi-tubular pyrolysis reactor 2, releasing a pyrolysis gas product; the gas product radially flows across a moving particle bed and enters a gas collecting internal component 6 through a pore; then, outlets of the gas collecting internal components of each row of four parallel tubular pyrolysis reactors are connected to the gas product collecting pipe 7, and the pyrolysis gas product is collected in a gas product condenser 8 for cooling and separation; the separated pyrolysis gas is mixed with air and introduced by regenerative burners 3 and burned as a fuel gas in the heating chamber 4 to supply heat for the pyrolysis reactor; a solid product after the pyrolysis reaction is discharged from the pyrolysis reactor through a solid product discharger 5 after cooling and heat exchange, and enters a downstream processing section. The whole process runs continuously.

In the present embodiment, compared with a pyrolysis apparatus without a gas collecting internal component in a tubular pyrolysis reactor, a heat transfer rate of the technology provided by the present application is increased by 1 time or more, a pyrolysis oil yield is increased by 1 time or more, and a dust content is reduced to 0.2% or less.

### Embodiment 6

A pyrolysis method based on a pyrolysis apparatus for solid hydrocarbon feedstock is provided, including the following steps:
a solid hydrocarbon feedstock is fed into sixteen tubular pyrolysis reactors through sixteen feeders 1, respectively, where the feedstock is heated and subjected to a pyrolysis reaction during a downward movement in a multi-tubular pyrolysis reactor 2, releasing a pyrolysis gas product; the gas product radially flows across a moving particle bed and enters a gas collecting internal component 6 through a pore; and then outlets of gas collecting internal components of each row of eight parallel tubular pyrolysis reactors are connected to the gas product collecting pipe 7, and the pyrolysis gas product is collected in a gas product condenser 8 for cooling and separation; the separated pyrolysis gas and an external natural gas are mixed with air and introduced by regenerative burners 3 and burned as a fuel gas in the heating chamber 4 to supply heat for the pyrolysis reactor; a solid product after the pyrolysis reaction is discharged from the pyrolysis reactor through a solid product discharger 5 after cooling and heat exchange, and enters a downstream processing section. The whole process runs continuously.

In the present embodiment, compared with a pyrolysis apparatus without a gas collecting internal component in a tubular pyrolysis reactor, a heat transfer rate of the technology provided by the present application is increased by 1.5 times or more, a pyrolysis oil yield is increased by 1 time or more, and a dust content is reduced to 0.1% or less.

Obviously, the above embodiments of the present application are only examples for clearly explaining the present application, and are not intended to limit the implementations of the present application. For those skilled in the art, other variations or changes in different forms can be made on the basis of the above description. It is not necessary and impossible to list all the implementations here. Any modifications, equivalent substitutions, improvements and the like made within the spirit and principles of the present application should be included in the protection scope of the claims of the present application.

What is claimed is:

1. A pyrolysis apparatus for solid hydrocarbon feedstock, comprising: a feeder, a multi-tubular pyrolysis reactor, regenerative burners, a heating chamber, a solid product discharger, a gas collecting internal component, a gas product collecting pipe and a gas product condenser;
wherein the multi-tubular pyrolysis reactor is formed by one tubular pyrolysis reactor or more tubular pyrolysis reactors in combination, the tubular pyrolysis reactor is generally cylindrical in shape, and the gas collecting internal component is arranged at a center of each reactor; the gas collecting internal component is cylindrical in shape, and the internal component is provided with a channel or a pore for allowing a gas product to pass through, a lower end of the internal component is opened into a material layer of the pyrolysis reactor, and an upper end of the internal component is in a gas-tight communication with the gas product collecting pipe, so as to guide a pyrolysis gas product out of the pyrolysis reactor and into the gas product condenser; a heating section of the multi-tubular pyrolysis reactor is placed in the heating chamber, and the tubular pyrolysis reactors are arranged in the heating chamber in a tube-by-tube manner; the heating chamber is an indoor combustion chamber, which provides heat for a pyrolysis reaction through combustion of a combustible gas, and one or more tubular pyrolysis reactors are arranged in the heating chamber; the regenerative burners are distributed symmetrically above and below the heating chamber or at sides of the heating chamber; the gas product collecting pipe is connected to outlets of gas collecting internal components of the tubular pyrolysis reactors in a same row, and introduces the pyrolysis gas product into the gas product condenser.

2. The pyrolysis apparatus for solid hydrocarbon feedstock according to claim 1, wherein the regenerative burner uses the combustible gas as a fuel, the combustible gas being selected from one of a pyrolysis gas, a natural gas, a gasified coal gas and a petroleum gas, or a combination of two or more thereof.

3. The pyrolysis apparatus for solid hydrocarbon feedstock according to claim 2, wherein the pyrolysis gas separated by the gas product condenser is used as a gas fuel.

4. A process method for a pyrolysis apparatus for solid hydrocarbon feedstock, comprising the following procedure:
a solid hydrocarbon feedstock is fed into a tubular pyrolysis reactor through a feeder, respectively, wherein the feedstock is heated and subjected to a pyrolysis reaction during its downward movement in a multi-tubular pyrolysis reactor, releasing a pyrolysis gas product;
the gas product flows radially across a moving particle bed, enters a gas collecting internal component through a pore or a channel, and then is collected to a gas product condenser through a gas product collecting pipe for cooling and separation;
the separated pyrolysis gas and/or an external fuel gas are mixed with air and introduced by regenerative burners and burned in a heating chamber to supply heat for the pyrolysis reactor; and
a solid product obtained after the pyrolysis reaction is discharged from the pyrolysis reactor through a solid product discharger after cooling and heat exchange, and enters a downstream processing section, the whole process running continuously.

5. The process method for a pyrolysis apparatus for solid hydrocarbon feedstock according to claim 4, wherein the regenerative burner uses a combustible gas as a fuel, the combustible gas being selected from one of a pyrolysis gas, a natural gas, a gasified coal gas and a petroleum gas, or a combination of two or more thereof.

6. The process method for a pyrolysis apparatus for solid hydrocarbon feedstock according to claim 5, wherein the pyrolysis gas separated by the gas product condenser is used as a gas fuel.
